(19) United States
(12) Patent Application Publication
(10) Pub. No.: US 2018/0043965 A1
(43) Pub. Date: Feb. 15, 2018

(54) ELECTRICALLY OPERATED BICYCLE

(71) Applicant: Sang-Ki BAEK, Yongin-si (KR)

(72) Inventor: Sang-Ki BAEK, Yongin-si (KR)

(21) Appl. No.: 15/308,769

(22) PCT Filed: Apr. 7, 2016
(86) PCT No.: PCT/KR2016/003618

§ 371 Date: Nov. 3, 2016

(30) Foreign Application Priority Data
Jan. 28, 2016 (KR) 10-2016-0010647

(51) Int. Cl. B62M 6/90; B62K 15/00

(52) U.S. Cl. CPC B62M 6/90; B62K 15/006

(57) ABSTRACT

Provided herein is an electrically operated bicycle including a first frame, a second frame coupled to the first frame and including a seat, a first axle frame supporting a front axle connected to a front wheel and rotatably connected to one end of the first frame, a second axle frame supporting a rear axle connected to a rear wheel, a driving member configured to apply a driving force to at least one of the front wheel and the rear wheel, a battery pack electrically connected to the driving member, and an engagement member coupled to the battery pack and configured to fix the battery pack to at least one of the first frame and the second frame.

### TECHNICAL FIELD

One or more embodiments of the present disclosure relate to electrically operated bicycles.

### BACKGROUND ART

Bicycles may be generally categorized into fixed frame bicycles and folding bicycles. Fixed frame bicycles have a simple and rigid structure, and when an electric bicycle is embodied as a fixed frame bicycle, a battery pack may be more easily installed inside a frame.

In general fixed frame bicycles, however, it is not easy to secure a space for fixing a battery pack according to the design of frames, and in some cases, a high-capacity battery pack cannot be employed.

In addition, when an electric bicycle is embodied as a folding bicycle, it is very inconvenient to install a battery pack in a frame, and an overall frame structure becomes complicated for the installation of a battery pack.

### DETAILED DESCRIPTION OF THE INVENTION

### Technical Problem

One or more embodiments of the present disclosure provide electrically operated bicycles having a high degree of freedom of installation of a battery pack. In addition, one or more embodiments of the present disclosure provide folding electrically operated bicycles having a much smaller size when folded, thus capable of being easily stored and transported and being highly portable.

### Technical Solution

According to an aspect of an embodiment, an electrically operated bicycle includes a first frame, a second frame coupled to the first frame and including a seat, a first axle frame supporting a front axle connected to a front wheel and rotatably connected to one end of the first frame, a second axle frame supporting a rear axle connected to a rear wheel, a driving member configured to apply a driving force to at least one of the front wheel and the rear wheel, a battery pack electrically connected to the driving member, a first engagement member coupled to the battery pack and configured to fix the battery pack to the first frame, and a second engagement member coupled to the battery pack and configured to fix the battery pack to the second frame.

In an embodiment, the first frame may include a 1-1 frame and a 1-2 frame separated from each other, and the electrically operated bicycle may further include a first hinge part between the 1-1 frame and the 1-2 frame and configured to bend the first frame in a direction in which the front wheel and the rear wheel overlap with each other.

In an embodiment, the electrically operated bicycle may further include a third frame with the first and second engagement members positioned thereat, a first fixing member between the third frame and the first frame, and a second fixing member between the third frame and the second frame.

In an embodiment, the third frame may include a 3-1 frame and a 3-2 frame separated from each other, and the electrically operated bicycle may further include a second hinge part between the 3-1 frame and the 3-2 frame and configured to bend the third frame in a direction in which the front wheel and the rear wheel overlap with each other.

In an embodiment, the third frame may include at least one bent portion.

In an embodiment, the electrically operated bicycle may further include a fourth frame between the third frame and at least one of the first fixing member and the second fixing member.

In an embodiment, the fourth frame may be configured to be inserted into the third frame.

In an embodiment, the electrically operated bicycle may further include a third hinge part between the third frame and the fourth frame in such a way that the fourth frame rotates about the third frame.

In an embodiment, the fourth frame may include a 4-1 frame and a 4-2 frame separated from each other, the electrically operated bicycle may further include a fourth hinge part between the 4-1 frame and the 4-2 frame in such a way that the 4-1 frame rotates about the 4-2 frame, and the 4-2 frame may be configured to be inserted into the third frame.

In an embodiment, the fourth frame may include a 4-1 frame and a 4-2 frame separated from each other, and the electrically operated bicycle may further include a fifth hinge part between the 4-1 frame and the 4-2 frame and configured to bend the fourth frame in a direction in which the front wheel and the rear wheel overlap with each other.

In an embodiment, the electrically operated bicycle may further include a fifth frame fixedly coupled to a frame structure of the electrically operated bicycle and a sixth hinge part between the fifth frame and at least one of the first fixing member and the second fixing member and configured to rotate the third frame in a direction in which the front wheel and the rear wheel overlap with each other.

Additional aspects, features, and advantages of the present disclosure in addition to those described above will be clearly understood from the accompanying drawings, the claims, and the detailed description, which will be described below.

### Advantageous Effects of the Invention

According to one or more embodiments of the present disclosure, electrically operated bicycles have a more simple structure for the installation of battery packs and thus the battery packs may be easily installed and detached, and high-capacity battery packs may be used and degrees of freedom of use and installation of battery packs may be increased by easily adjusting installation angles of such battery packs.

In addition, the electrically operated bicycles may be simply used as folding bicycles and have a much smaller size when folded, and thus may be easily stored and transported and be highly portable.

### DESCRIPTION OF THE DRAWINGS

FIG. 1 is a schematic side view of an electrically operated bicycle according to an embodiment.

FIG. 2 is a side view of the electrically operated bicycle of FIG. 1 from which a third frame is detached.

FIG. 3 is a schematic side view of an electrically operated bicycle according to another embodiment.

FIG. 4 is a schematic side view of an electrically operated bicycle according to another embodiment.

FIGS. 5A and 5B are schematic side views illustrating a method of folding the electrically operated bicycle of FIG. 4, according to an embodiment.

FIG. 6 is a schematic side view illustrating a method of folding the electrically operated bicycle of FIG. 4, according to another embodiment.

FIGS. 7A and 7B are schematic side views of an electrically operated bicycle according to another embodiment.

FIG. 8 is a side view of an assembly of third and fourth frames according to another embodiment.

FIG. 9 is a side view of an assembly of third and fourth frames according to another embodiment.

FIG. 10 is a side view of an assembly of third and fourth frames according to another embodiment.

FIG. 11 is a side view of n assembly of third and fourth frames according to another embodiment.

FIG. 12 is a side view of an assembly of h d and fourth frames according to another embodiment.

FIG. 13 is a side view of n assembly of third and fourth frames according to another embodiment.

FIG. 14 is a side view of an assembly of third and fifth frames according to another embodiment.

FIG. 15 is a side view of an assembly of third to fifth frames according to another embodiment.

FIG. 16 is a side view of an assembly of third to fifth frames according to another embodiment.

FIG. 17 is a view of first and second fixing members, according to an embodiment.

FIGS. 18 and 19 are views each illustrating a battery pack installed at a third frame, according to embodiments.

FIG. 20 is a view illustrating an installation state of a battery pack, according to another embodiment.

### MODE OF THE INVENTION

As the present disclosure allows for various changes and numerous embodiments, particular embodiments will be illustrated in the drawings and described in detail in the written description. Effects and features of the present disclosure and methods for achieving them will be clearly understood with reference to the drawings and embodiments described below in detail. The present disclosure may, however, be embodied in many different forms and should not be construed as being limited to the embodiments set forth herein.

Hereinafter, embodiments of the present disclosure will be described in detail with reference to the accompanying drawings, and like reference numerals in the drawings denote like elements, and thus their description will not be repeated.

In the embodiments below, terms first, second, and the like do not have restrictive meanings and are only used to distinguish one element from another.

In the embodiments below, an expression used in the singular encompasses the expression of the plural, unless it has a clearly different meaning in the context.

In addition, it is to be understood that the terms such as “including” or “having,” and the like, are intended to indicate the existence of the features or elements disclosed in the specification, and are not intended to preclude the possibility that one or more other features or elements may be added.

In the drawings, the sizes of elements may be exaggerated or reduced for convenience of explanation. For example, the size and thickness of each element in the drawings are arbitrarily illustrated for convenience of explanation and thus the present disclosure is not particularly limited to the illustrations.

When an embodiment may be implemented in a different way, a certain process may be changed. For example, two consecutively described processes may be performed substantially at the same time, or may be performed in an order opposite to the described order.

In the embodiments below, it will be understood that when a film, a region, an element, or the like is referred to as being “connected” to another film, region or element, it may be directly connected to the other element or intervening elements may be present.

In the present specification, like reference numerals denote like elements.

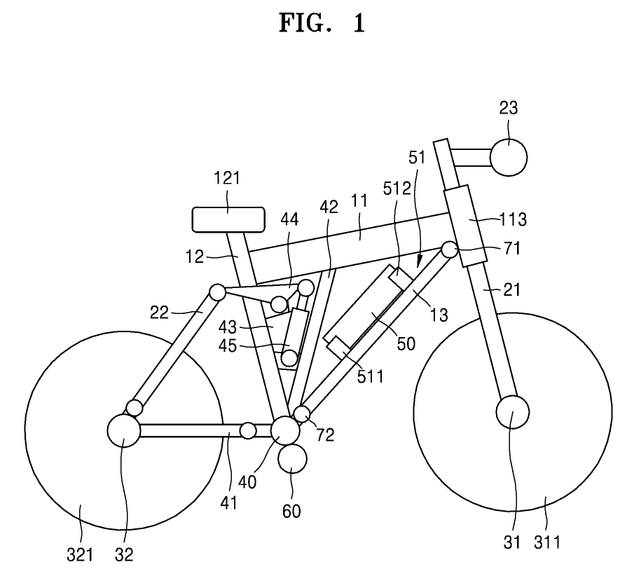

FIG. 1 is a schematic side view of an electrically operated bicycle according to an embodiment.

Referring to FIG. 1, the electrically operated bicycle includes a first frame 11, a second frame 12, a first axle frame 21, a second axle frame 22, a driving member 60, a battery pack 50, and an engagement member 51.

The first frame 11 may be arranged substantially horizontally and may be provided with a cylindrical frame 113 at one end thereof facing forward. The first axle frame 21 may be rotatably and penetratively coupled to the cylindrical frame 113.

The first axle frame 21 may rotatably support a front axle 31 connected to a front wheel 311. The first axle frame 21 may be provided with a steering handlebar 23 coupled to an upper end thereof.

The second frame 12 may be coupled to the first frame 11 and, in FIG. 1, may be coupled to the other end of the first frame 11, but the present disclosure is not limited to the above example. For example, the second frame 12 may be coupled to a portion of the first frame 11.

A seat 121 may be coupled to the second frame 12. The second frame 12 may include a pedal part 40 and, although the pedal part 40 is schematically illustrated in the drawings, the pedal part 40 may include a pedal frame positioned at a lower end of the second frame 12 and a pedal structure including a gear part, a chain, a bearing, and the like.

The second axle frame 22 may rotatably support a rear axle 32 connected to a rear wheel 321. The second axle frame 22 may be connected to the first frame 11 or indirectly connected to the first frame 11, for example, via another member.

A first auxiliary frame 41 may be connected between the rear axle 32 and the pedal part 40, and a second auxiliary frame 42 may be connected between the first frame 11 and the pedal part 40.

A separate support frame 43 may be positioned between the second frame 12 and the second auxiliary frame 42, and the support frame 43 may be connected to a central portion of a buffer frame 44. The buffer frame 44 may have a first end connected to a buffer device 45 coupled to the support frame 43 and a second end connected to the second axle frame 22. Accordingly, the buffer device 45 may absorb impacts transmitted to the rear wheel 321. The buffer device 45 may be a shock absorber.

In addition, the electrically operated bicycle may further include the driving member 60 to apply a driving force to at least one of the front wheel 311 and the rear wheel 321. The driving member 60 may be an electric motor which generates a driving force by electricity and a part thereof. In the accompanying drawings, the driving member 60 may be illustrated as a mid-motor adjacently installed at the pedal part 40, but the present disclosure is not limited to the above example. For example, the driving member 60 may be a hub motor coupled to the front axle 31 and/or the rear axle 32. In addition, the driving member 60 may have a structure in combination of the two forms.

The electrically operated bicycle may further include a third frame 13. As illustrated in FIG. 1, the third frame 13 may be coupled to the first and second frames 11 and 12 therebetween. For the coupling of the third frame 13, the electrically operated bicycle may further include a first fixing member 71 between the third frame 13 and the first frame 11 and a second fixing member 72 between the third frame 13 and the second frame 12. Although not illustrated in detail in the drawings, the first and second fixing members 71 and 72 may include coupling holes at opposite ends of the third frame 13 and the first and second frames 11 and 12, and each fixing member may include a coupling member such as a bolt fastened with the coupling hole. In addition to the bolt, the coupling member may be a device coupled or detached by user's simple operation, such as a Quick Release (OR). The coupling member may also be applied to all the embodiments of the present disclosure.

The first fixing member 71 may be positioned adjacent to a front end of the first frame 11, for example, the cylindrical frame 113, and the second fixing member 72 may be positioned adjacent to a lower end of the second frame 12, for example, the pedal part 40. The first fixing member 71 and the second fixing member 72 may detachably couple the third frame 13 to the first frame 11 and the second frame 12, respectively.

The electrically operated bicycle may include the battery pack 50 electrically connected to the driving member 60 and the engagement member 51 coupled to the battery pack 50. The engagement member 51 is configured to fix the battery pack 50 to at least one of the first frame 11 and the second frame 12, and the battery pack 50 may be selectively fixed according to user's manipulation.

In an embodiment, as illustrated in FIG. 1, the engagement member 51 includes a first engagement member 511 and a second engagement member 512, and each of the first engagement member 511 and the second engagement member 512 may be coupled to the third frame 13. Accordingly, the battery pack 50 may be fixed to the first and second frames 11 and 12 via the third frame 13.

The first engagement member 511 and the second engagement member 512 may be positioned at the third frame 13 to selectively fix the battery pack 50, and the battery pack 50 may be detached from the first engagement member 511 and the second engagement member 512 according to user's manipulation.

In an embodiment, the battery pack 50 may be disposed so as to be detached by a user and thus may be easily detached and coupled by a user.

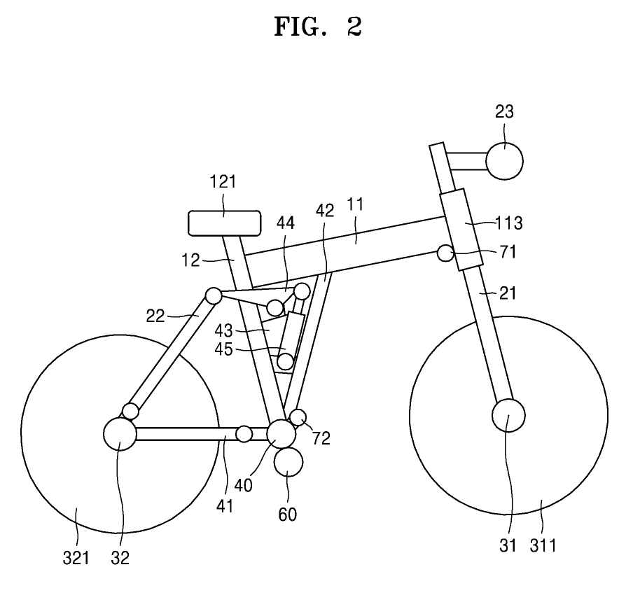

In an embodiment, the third frame 13 with the battery pack 50 coupled thereto may be detachably coupled to the first and second fixing members 71 and 72. Thus, the third frame 13 may be detached by a user from the first and second fixing members 71 and 72 and thus, as illustrated in FIG. 2, the electrically operated bicycle may be used the same as a general bicycle.

The embodiment illustrated in FIG. 2 and modifications thereof may be equally applied to all the embodiments of the present disclosure.

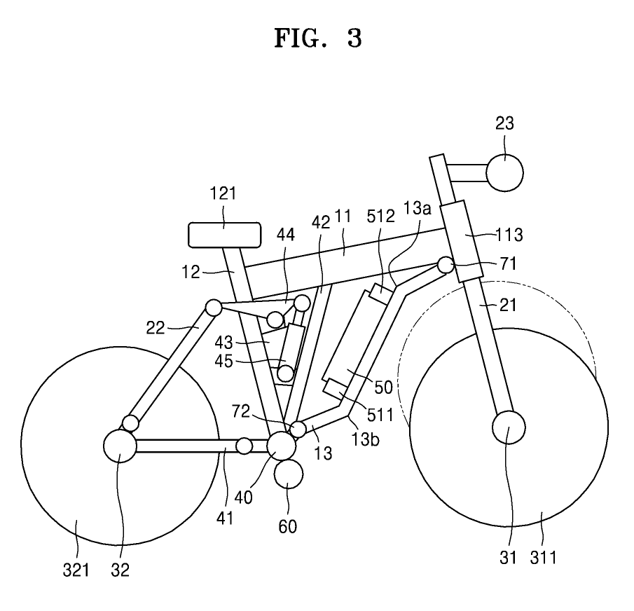

FIG. 3 is a schematic side view of an electrically operated bicycle according to another embodiment.

Referring to FIG. 3, in the electrically operated bicycle, the third frame 13 includes at least one bent portion. According to the embodiment illustrated in FIG. 3, the third frame 13 includes the first and second bent portions 13a and 13b that are bent upward and downward in directions different from each other, and the first bent portion 13a positioned on an upper side is in a form bent backward and, accordingly, a buffer space of the front wheel 311 may be more widely secured. The battery pack 50 may have a steep fixed angle.

The embodiment illustrated in FIG. 3 and modifications thereof may be equally applied to all the embodiments of the present specification.

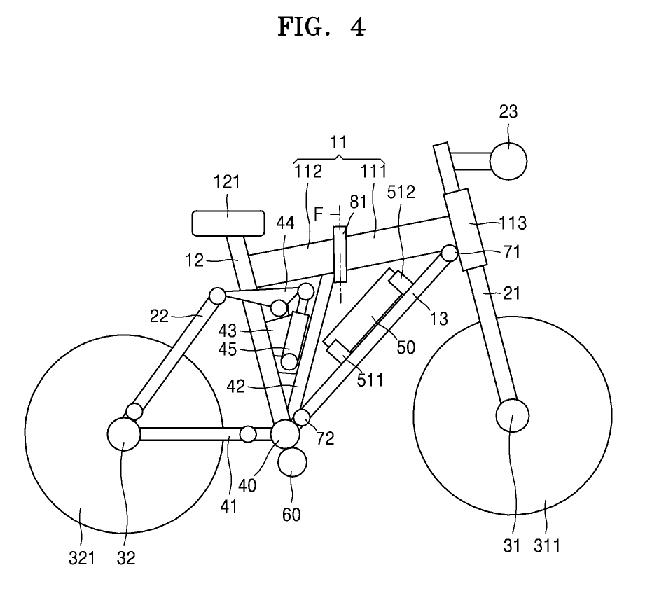

FIG. 4 is a schematic side view of an electrically operated bicycle according to another embodiment.

In the electrically operated bicycle according to the present embodiment, the first frame 11 includes a 1-1 frame 111 and a 1-2 frame 112 separated from each other, and the 1-1 frame 111 and the 1-2 frame 112 are coupled to each other by a first hinge part 81.

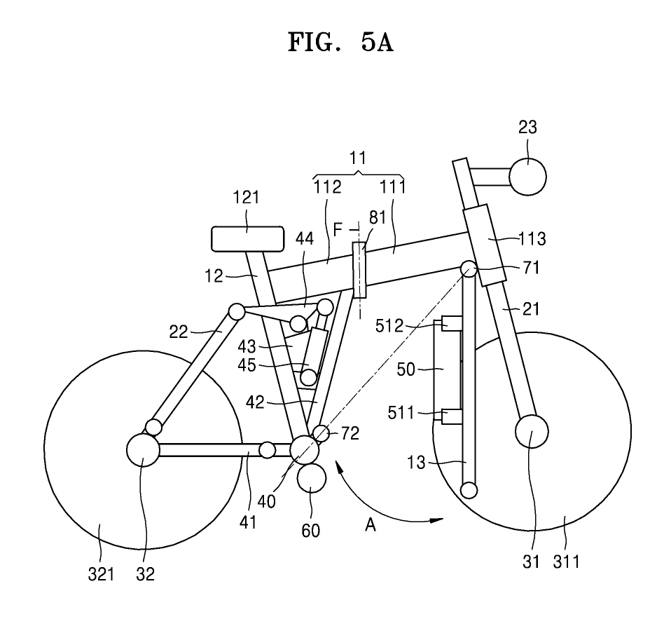

The first hinge part 81 is disposed between the 1-1 frame 111 and the 1-2 frame 112 and is configured to bend the first frame 11 about a folding axis F. By bending the first frame 11 by the first hinge part 81, as illustrated in FIG. 5B, the electrically operated bicycle may be folded such that the front wheel 31 and the rear wheel 32 overlap with each other.

Thus, the electrically operated bicycle may be used by a user as a folding bicycle.

In an embodiment, to fold the electrically operated bicycle, as illustrated in FIG. 5A, the third frame 13 may be detached from the second fixing member 72. In this regard, the third frame 13 may be coupled by the first fixing member 71 to the first frame 11, in particular, the 1-1 frame 111. The third frame 13 may be rotatably coupled to the first fixing member 71 and, accordingly, the third frame 13 rotates downward A and is hung from the first fixing member 71.

In this state, as illustrated in FIG. 5B, the electrically operated bicycle may be folded in half by bending the first frame 11 about the folding axis F of the first hinge part 81 in a folding direction B.

As such, the electrically operated bicycle may be folded in half by a simple manipulation, i.e., by separating the third frame 13 from the second fixing member 72 without interference with the battery pack 50.

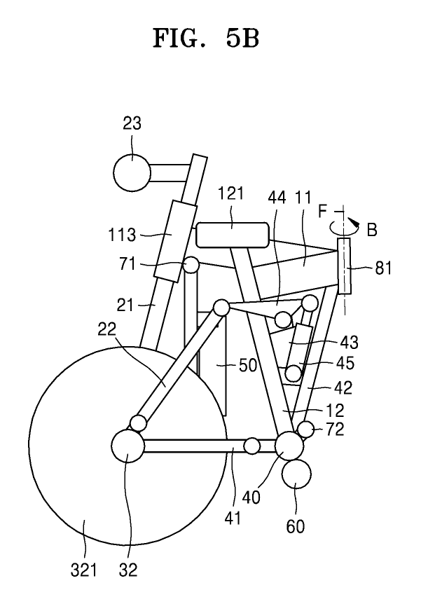

In addition, the electrically operated bicycle according to the embodiment illustrated in FIG. 4 may be folded in half, as illustrated in FIG. 6, by separating the third frame 13 from the first and second fixing members 71 and 72 to completely separate the battery pack 50 from the bicycle and then by bending the first frame 11 about the folding axis F of the first hinge part 81 in the folding direction B.

These embodiments and modifications thereof may be applied to all the embodiments of the present specification.

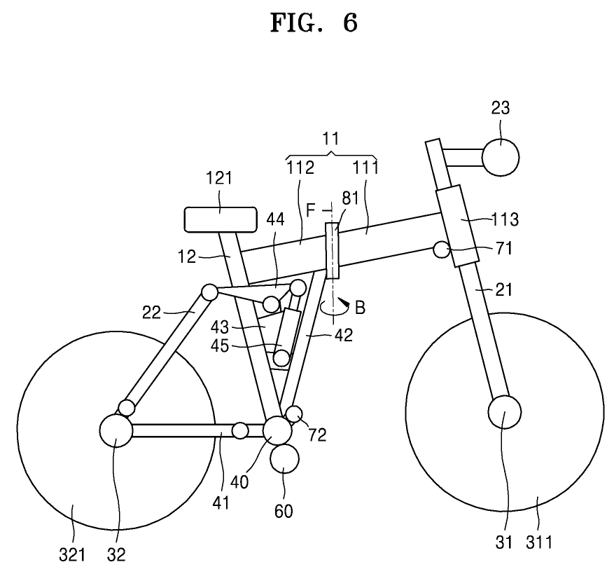

FIGS. 7A and 7B are schematic side views of an electrically operated bicycle according to another embodiment.

Referring to FIG. 7A, the third frame 13 includes a 3-1 frame 131 and a 3-2 frame 132 separated from each other, and the 3-1 frame 131 and the 3-2 frame 132 may be coupled to each other by a second hinge part 82. The second hinge part 82 is disposed between the 3-1 frame 131 and the 3-2 frame 132 to bend the third frame 13 about a second folding axis F2 in the folding direction B. In this regard, the first hinge part 81 may also bend the first frame 11 about the first folding axis F1 and thus the first frame 11 and the third frame 13 may be bent by the first hinge part 81 and the second hinge part 82 and thus, as illustrated in FIG. 7B, the front wheel 31 and the rear wheel 32 may be bent to overlap with each other. The second folding axis F2 of the second hinge part 82 may be in a direction parallel to the first folding axis F1 of the first hinge part 81. Accordingly, the electrically operated bicycle may be easily folded about the first hinge part 81 and the second hinge part 82.

In the above embodiment, the battery pack 50 and the engagement member 51 may be installed at the 3-1 frame 131 and, accordingly, the electrically operated bicycle may be easily folded in half by a user without separation of and interference with the battery pack 50.

These embodiments and modifications thereof may be applied to all the embodiments of the present specification.

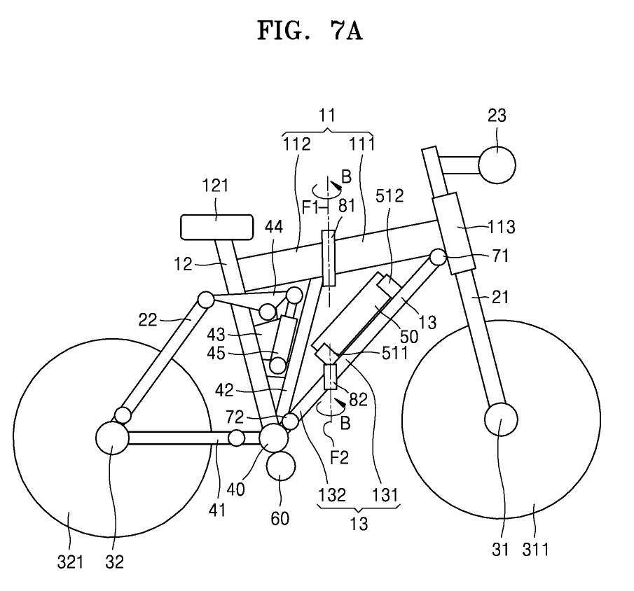

FIG. 8 is a view of the third frame 13 according to another embodiment. In the embodiment illustrated in FIG. 8, a fourth frame 14 may be further disposed between the third frame 13 and the first fixing member 71.

In an embodiment, a third hinge part 83 may be further disposed between the fourth frame 14 and the third frame 13. The fourth frame 14 may be rotated by the third hinge part 83 along a rotation direction C about the third frame 13. The rotation direction C may be on a plane parallel to a direction facing front and rear directions of the bicycle.

According to the present embodiment, the third frame 13 is coupled to the fourth frame 14 and a coupling angle therebetween may vary and, consequently, the third frame 13 may be positioned downward. Accordingly, a fixed angle of the battery pack 50 may be easily adjusted, and the battery pack 50 may be more easily detached by a user. In addition, the third frame 13 is coupled to the fourth frame 14 to have a bent structure and thus the third frame 13 at which the battery pack 50 is installed may have a sufficiently long length and, accordingly, a higher capacity battery pack may be mounted.

In FIG. 8, the fourth frame 14 is disposed between the first fixing member 71 and the third frame 13, but the present disclosure is not limited to the above example. For example, the fourth frame 14 may be positioned between the second fixing member 72 and the third frame 13.

The embodiment illustrated in FIG. 8 and modifications thereof may be equally applied to all the embodiments of the present specification.

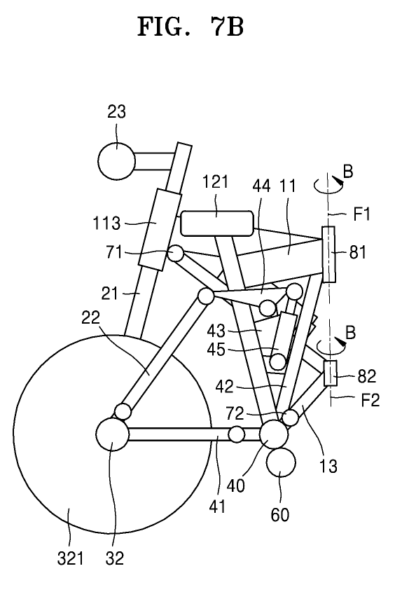

In an embodiment illustrated in FIG. 9, the fourth frame 14 may be provided with a position adjustment groove 143 formed along a length direction thereof to change an installation position of the first fixing member 71. Accordingly, the installation position of the first fixing member 71 is changed along a length direction D of the fourth frame 14, and an effect of changing the length of the fourth frame 14 may be obtained. Thus, an assembly of the third and fourth frames 13 and 14 according to the present embodiment may be applied by a user to bicycles with various sizes and a degree of freedom of installation may be increased.

As described above, in FIG. 9, the fourth frame 14 is positioned between the first fixing member 71 and the third frame 13, but the present disclosure is not limited to the above example. For example, the fourth frame 14 may be positioned between the second fixing member 72 and the third frame 13 and, in this case, the position adjustment groove 143 may also be equally applied.

The embodiment illustrated in FIG. 9 and modifications thereof may be equally applied to all the embodiments of the present specification.

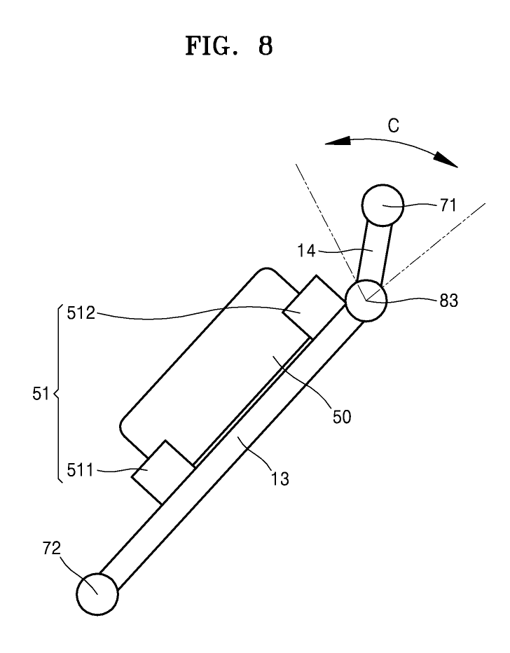

According to an embodiment illustrated in FIG. 10, the fourth frame 14 may be inserted into the third frame 13. Accordingly, a length E of the fourth frame 14 may be changed. Thus, an assembly of the third and fourth frames 13 and 14 according to the present embodiment may be applied by a user to bicycles with various sizes and a degree of freedom of installation may be increased.

As described above, in FIG. 10, the fourth frame 14 is positioned between the first fixing member 71 and the third frame 13, but the present disclosure is not limited to the above example. For example, the fourth frame 14 may be positioned between the second fixing member 72 and the third frame 13 and, in this case, the fourth frame 14 may be inserted into the third frame 13.

The embodiment of FIG. 10 and modifications thereof may be equally applied to all the embodiments of the present specification.

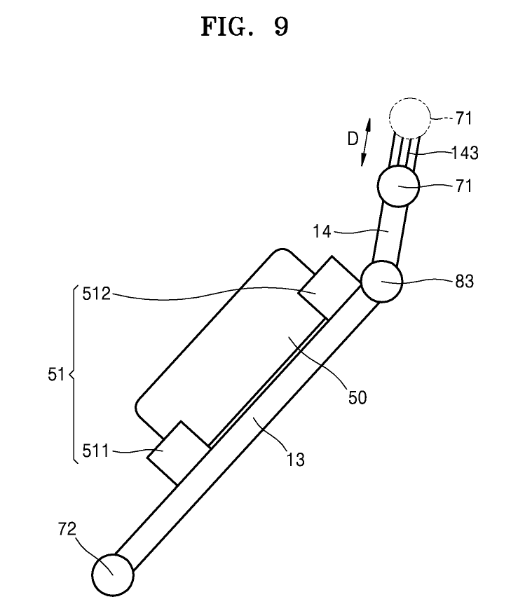

In an embodiment illustrated in FIG. 11, one fourth frame 14a may be coupled to the first fixing member 71 and the third frame 13 therebetween via the third hinge part 83, and another fourth frame 14b may be disposed between the second fixing member 72 and the third frame 13. The other fourth frame 14b may be inserted into the third frame 13. Accordingly, a user may obtain both an effect of changing the length of the third frame 13 and an effect of changing an installation angle of the battery pack 50. Although FIG. 11 illustrates that the fourth frame 14a is coupled to the first fixing member 71 and the third frame 13 therebetween via the third hinge part 83 and the other fourth frame 14b is disposed between the second fixing member 72 and the third frame 13, the present disclosure is not limited to the above example. For example, the fourth frame 14a may be coupled to the first fixing member 71 and the third frame 13 therebetween to be inserted into the third frame 13, and the other fourth frame 14b may be coupled to the second fixing member 72 and the third frame 13 therebetween via the third hinge part 83.

The embodiment of FIG. 11 and modifications thereof may be equally applied to all the embodiments of the present specification.

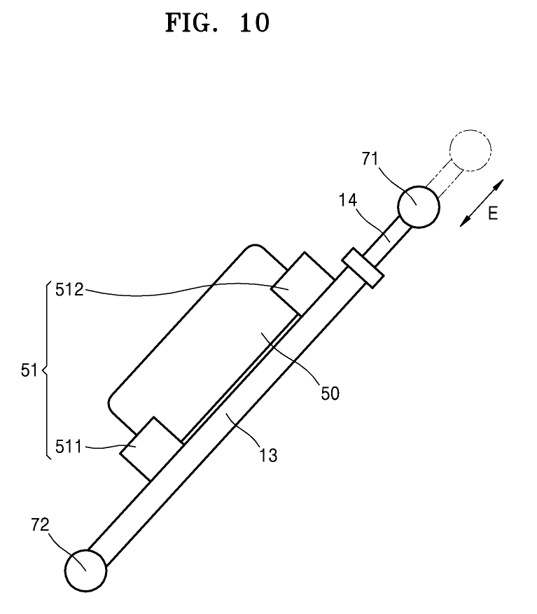

In an embodiment illustrated in FIG. 12, the fourth frame 14 may include a 4-1 frame 141 and a 4-2 frame 142 separated from each other. In addition, a fourth hinge part 84 may be disposed between the 4-1 frame 141 and the 4-2 frame 142 so that the 4-1 frame 141 rotates about the 4-2 frame 142. In addition, the 4-2 frame 142 may be inserted into the third frame 13. Thus, an assembly of the third and fourth frames 14 according to the present embodiment may be applied by a user to bicycles with various sizes and a degree of freedom of installation may be increased.

In FIG. 12, the fourth frame 14 is disposed between the first fixing member 71 and the third frame 13, but the present disclosure is not limited to the above example. For example, the fourth frame 14 may also be disposed between the second fixing member 72 and the third frame 13.

The embodiment of FIG. 12 and modifications thereof may be equally applied to all the embodiments of the present specification.

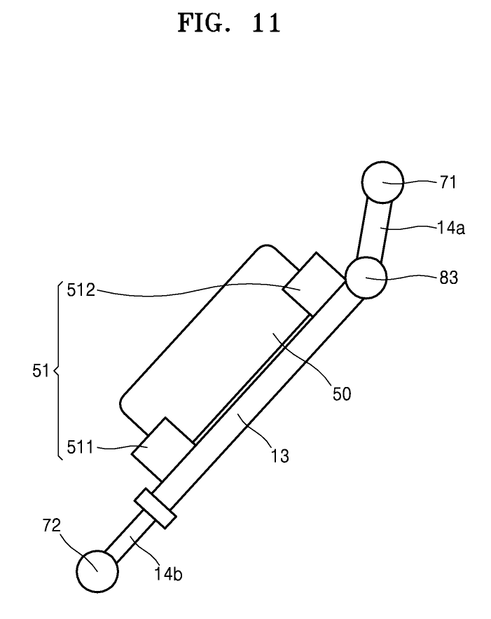

According to an embodiment illustrated in FIG. 13, the fourth frame 14 may be disposed between the second fixing member 72 and the third frame 13, and the fourth frame 14 may be coupled to the third frame 13 by the third hinge part 83. Thus, an angle between the third and fourth frames 13 and 14 may be changed about the third hinge part 83.

In addition, the fourth frame 14 includes the 4-1 frame 141 and the 4-2 frame 142 separated from each other, and the 4-1 frame 141 and the 4-2 frame 142 may be coupled to each other by a fifth hinge part 85.

The fifth hinge part 85 is disposed between the 4-1 frame 141 and the 4-2 frame 142 to bend the fourth frame 14 in the folding direction B about a third folding axis F3. In this regard, since the first hinge part 81 may bend the first frame 11 about the first folding axis F1, the first frame 11 and the fourth frame 14 are bent by the first hinge part 83 and the fifth hinge part 85, respectively and accordingly, the front wheel 31 and the rear wheel 32 may be folded to overlap with each other. The third folding axis F3 of the fifth hinge part 85 may be in a direction parallel to the first folding axis F1 of the first hinge part 81. Accordingly, the electrically operated bicycle may be easily folded about the first hinge part 81 and the fifth hinge part 85.

The fourth frame 14 may also be disposed between the first fixing member 71 and the third frame 13 and the aforementioned embodiment may be equally applied thereto.

The embodiment of FIG. 13 and modifications thereof may be equally applied to all the embodiments of the present specification.

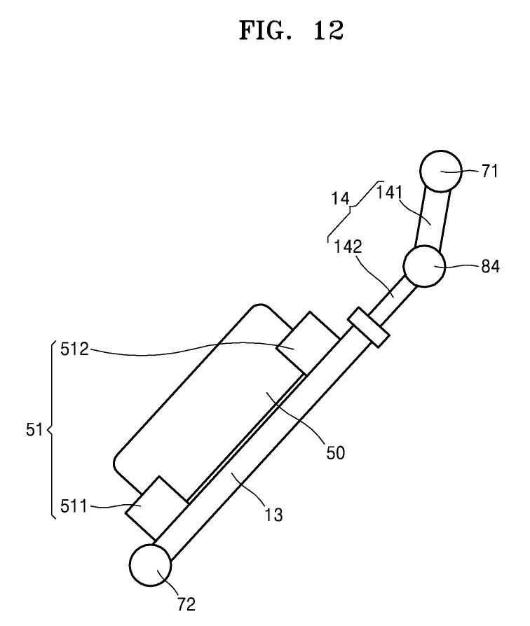

According to an embodiment illustrated in FIG. 14, a sixth hinge part 86 may be coupled to a fifth frame 15 fixedly coupled to a bicycle frame structure, and the second fixing member 72 may be coupled to the sixth hinge part 86.

The sixth hinge part 86 is configured to rotate the third frame 13 about a fourth folding axis F4 in the folding direction B. In this regard, since the first hinge part 81 may bend the first frame 11 about the first folding axis F1, the first frame 11 is bent by the first hinge part 81 and the fourth frame 13 is rotated by the sixth hinge part 86 and accordingly, the front wheel 31 and the rear wheel 32 may be folded to overlap with each other. The fourth folding axis F4 of the sixth hinge part 86 may be in a direction parallel to the first folding axis F1 of the first hinge part 81. Accordingly, the electrically operated bicycle may be easily folded about the first hinge part 81 and the sixth hinge part 86.

The fifth frame 15 and the sixth hinge part 86 may also be coupled to the first fixing member 71 and the aforementioned embodiment may be equally applied thereto.

The embodiment of FIG. 14 and modifications thereof may be equally applied to all the embodiments of the present specification.

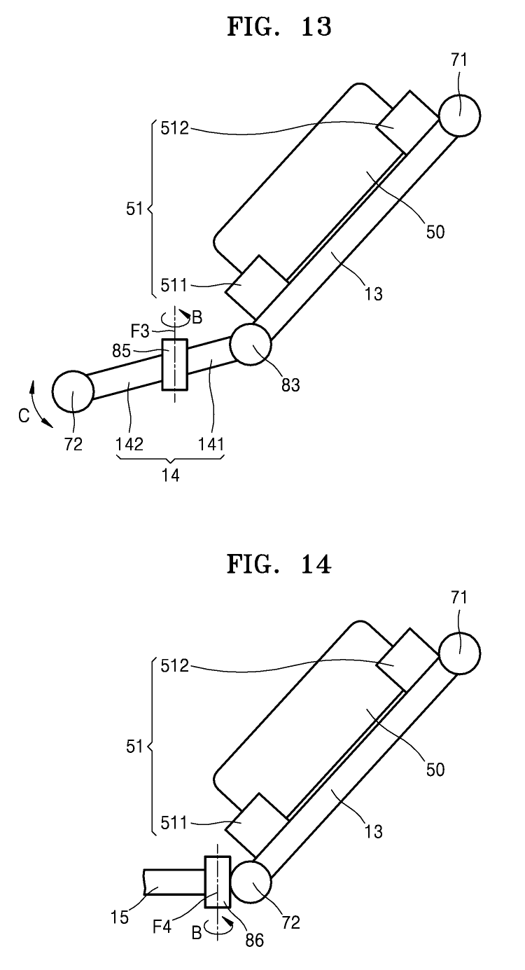

According to an embodiment illustrated in FIG. 15, the sixth hinge part 86 may be coupled to the fifth frame 15 fixedly coupled to a bicycle frame structure, the second fixing member 72 may be coupled to the sixth hinge part 86, and the fourth frame 14 may be further disposed between the second fixing member 72 and the third frame 13. In addition, the third hinge part 83 may be disposed between the fourth frame 14 and the third frame 13.

As in the embodiment described above, the sixth hinge part 86 is configured to rotate the third frame 13 about the fourth folding axis F4 in the folding direction B. In this regard, since the first hinge part 81 may bend the first frame 11 about the first folding axis F1, the first frame 11 is bent by the first hinge part 81 and the fourth frame 13 is rotated by the sixth hinge part 86 and accordingly, the front wheel 31 and the rear wheel 32 may be folded to overlap with each other. The fourth folding axis F4 of the sixth hinge part 86 may be in a direction parallel to the first folding axis F1 of the first hinge part 81. Accordingly, the electrically operated bicycle may be easily folded about the first hinge part 81 and the sixth hinge part 86. In this embodiment, the installation angle of the battery pack 50 may be easily changed, and the bicycle may be easily folded.

Also, the fifth frame 15 and the sixth hinge part 86 may be coupled to the first fixing member 71 and the fourth frame 14 may be coupled to the second fixing member 72 and the third frame 13 therebetween via the third hinge part 83, and the aforementioned embodiment may be equally applied thereto.

The embodiment of FIG. 15 and modifications thereof may be equally applied to all the embodiments of the present specification.

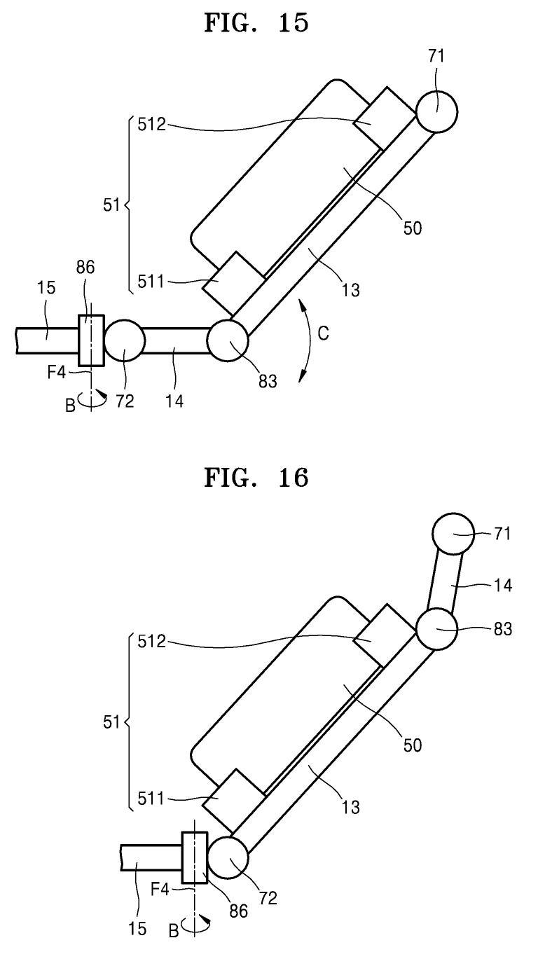

According to an embodiment illustrated in FIG. 16, the fourth frame 14 may be coupled to the first fixing member 71 and the third frame 13 therebetween via the third hinge part 83, and the second fixing member 72 may be coupled to the sixth hinge part 86 with the fifth frame 15 coupled thereto. Although not shown in the drawing, the fourth frame 14 may be coupled to the second fixing member 72 and the third frame 13 therebetween via the third hinge part 83, and the first fixing member 71 may be coupled to the sixth hinge part 86 coupled to the fifth frame 15. Also in this embodiment, the installation angle of the battery pack 50 may be easily changed and the bicycle may be easily folded.

The embodiment of FIG. 16 and modifications thereof may be equally applied to all the embodiments of the present specification.

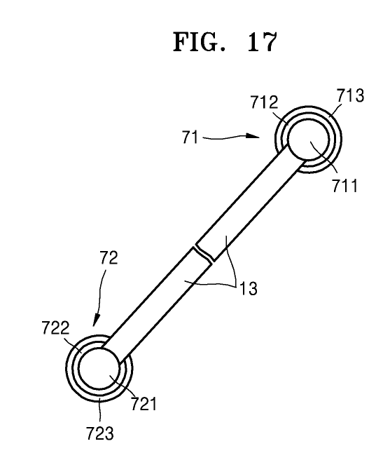

FIG. 17 is a view more particularly illustrating the first and second fixing members 71 and 72, according to an embodiment.

The first fixing member 71 may include a fixing member 711 on a side of the third frame 13 and a 1-2 fixing member 712 on a side of a main frame of the bicycle. Thus, the first fixing member 71 couples the third frame 13 to the main frame of the bicycle, e.g., the first frame 11 by engagement of the 1-1 fixing member 711 with the 1-2 fixing member 712.

Similarly, the second fixing member 72 may include a 2-1 fixing member 721 on a side of the third frame 13 and a 2-2 fixing member 722 on a side of a main frame of the bicycle. Thus, the second fixing member 72 couples the third frame 13 to the main frame of the bicycle, e.g., the second frame 12 by engagement of the 2-1 fixing member 721 with the 2-2 fixing member 722.

In this regard, according to an embodiment of the present disclosure, a 1-3 fixing member 713 may be further disposed between the 1-1 fixing member 711 and the 1-2 fixing member 712. The 1-3 fixing member 713 may be a buffer member which absorb various tolerances. That is, problems, e.g., bending of the third frame 13 according to tolerances of hinge parts functioning when the bicycle is folded may be solved using the 1-3 fixing member 713.

According to an embodiment, a 2-3 fixing member 723 may be further disposed between the 2-1 fixing member 721 and the 2-2 fixing member 722. The 2-3 fixing member 723 may also be used as a buffer member. The 2-3 fixing member 723 functions the same as the 1-3 fixing member 713 described above.

The embodiment of FIG. 17 and modifications thereof may be equally applied to all the embodiments of the present disclosure.

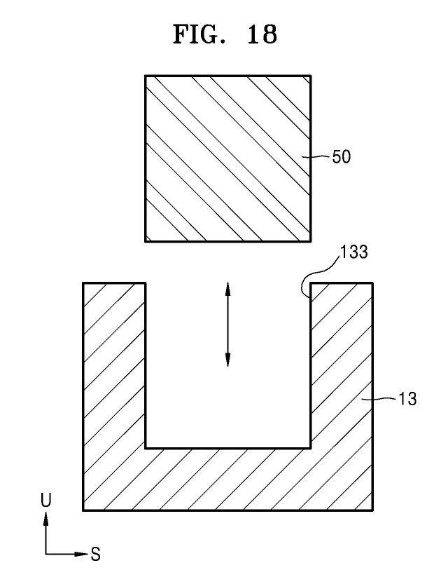

FIG. 18 illustrates a state in which the battery pack 50 is installed at the third frame 13. In the embodiment illustrated in FIG. 18, the third frame 13 may include a first engagement groove 133. The first engagement groove 133 is an opening formed upward U and accordingly, a user may install and detach the battery pack 50 at and from the third frame 13 downward and upward, respectively.

FIG. 19 illustrates a state in which the battery pack 50 is installed at the third frame 13. In the embodiment illustrated in FIG. 19, the third frame 13 may include a second engagement groove 134. The second engagement groove 134 is an opening formed in a side direction S and accordingly, a user may install and detach the battery pack 50 at and from the third frame 13 in a lateral direction.

The embodiment(s) illustrated in FIG. 18 and/or FIG. 19 and modifications thereof may be equally applied to all the embodiments of the present specification.

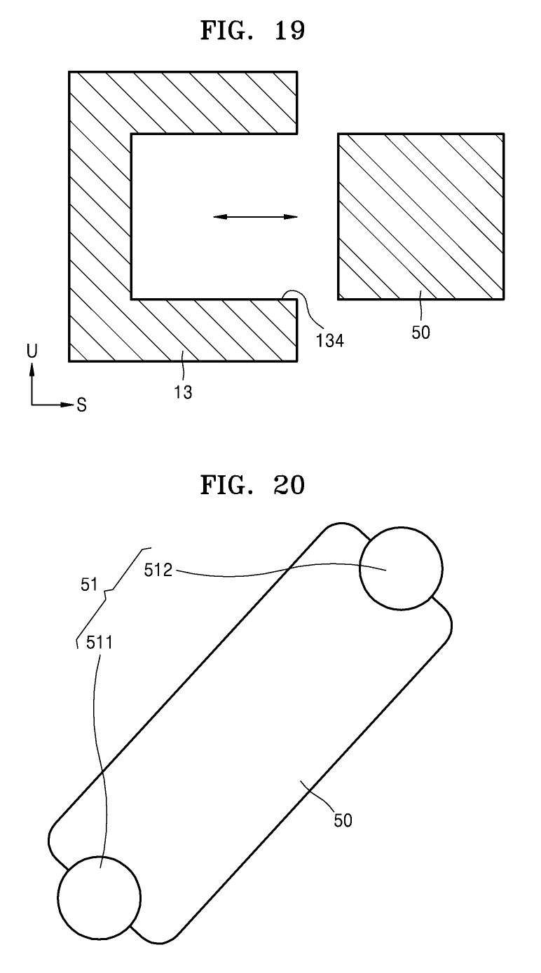

In the embodiments described above, the battery pack 50 is fixed to the third frame 13 by the engagement member 51, and the battery pack 50 is fixed to the frame of the bicycle by the third frame 13, but the present disclosure is not limited to the above example. As in an embodiment illustrated in FIG. 20, the first and second engagement members 511 and 512 coupled to opposite ends of the battery pack 50 may be detachably coupled to the first frame 11 and the second frame 12, respectively. Thus, an electrically operated bicycle having a more simple structure may be provided.

While one or more embodiments have been described with reference to the figures, it will be understood by those of ordinary skill in the art that various changes in form and details may be made therein without departing from the spirit and scope as defined by the following claims.

### INDUSTRIAL APPLICABILITY

One or more embodiments of the present disclosure relate to electrically operated bicycles.

1. An electrically operated bicycle comprising:
a first frame;
a second frame coupled to the first frame and comprising a seat;
a first axle frame supporting a front axle connected to a front wheel and rotatably connected to one end of the first frame;
a second axle frame supporting a rear axle connected to a rear wheel;
a driving member configured to apply a driving force to at least one of the front wheel and the rear wheel;
a battery pack electrically connected to the driving member;
a first engagement member coupled to the battery pack and configured to fix the battery pack to the first frame; and
a second engagement member coupled to the battery pack and configured to fix the battery pack to the second frame.

2. The electrically operated bicycle of claim 1, wherein the first frame comprises a 1-1 frame and a 1-2 frame separated from each other and,
wherein the electrically operated bicycle further comprises a first hinge part between the 1-1 frame and the 1-2 frame and configured to bend the first frame in a direction in which the front wheel and the rear wheel overlap with each other.

3. The electrically operated bicycle of claim 1, further comprising:
a third frame with the first and second engagement members positioned thereat;
a first fixing member between the third frame and the first frame; and
a second fixing member between the third frame and the second frame.

4. The electrically operated bicycle of claim 3, wherein the third frame comprises a 3-1 frame and a 3-2 frame separated from each other and,
wherein the electrically operated bicycle further comprises a second hinge part between the 3-1 frame and the 3-2 frame and configured to bend the third frame in a direction in which the front wheel and the rear wheel overlap with each other.

5. The electrically operated bicycle of claim 3, wherein the third frame comprises at least one bent portion.

6. The electrically operated bicycle of claim 3, further comprising a fourth frame between the third frame and at least one of the first fixing member and the second fixing member.

7. The electrically operated bicycle of claim 6, wherein the fourth frame is configured to be inserted into the third frame.

8. The electrically operated bicycle of claim 6, further comprising a third hinge part provided between the third frame and the fourth frame in such a way that the fourth frame rotates about the third frame.

9. The electrically operated bicycle of claim 6, wherein the fourth frame comprises a 4-1 frame and a 4-2 frame separated from each other,
wherein the electrically operated bicycle further comprises a fourth hinge part provided between the 4-1 frame and the 4-2 frame in such a way that the 4-1 frame rotates about the 4-2 frame, and
wherein the 4-2 frame is configured to be inserted into the third frame.

10. The electrically operated bicycle of claim 6, wherein the fourth frame comprises a 4-1 frame and a 4-2 frame separated from each other and
wherein the electrically operated bicycle further comprises a fifth hinge part between the 4-1 frame and the 4-2 frame and configured to bend the fourth frame in a direction in which the front wheel and the rear wheel overlap with each other.

11. The electrically operated bicycle of claim 3, further comprising:
a fifth frame fixedly coupled to a frame structure of the electrically operated bicycle; and
a sixth hinge part between the fifth frame and at least one of the first fixing member and the second fixing member and configured to rotate the third frame in a direction in which the front wheel and the rear wheel overlap with each other.

12. The electrically operated bicycle of claim 2, further comprising:
a third frame with the first and second engagement members positioned thereat;
a first fixing member between the third frame and the first frame; and
a second fixing member between the third frame and the second frame.

13. The electrically operated bicycle of claim 12, wherein the third frame comprises a 3-1 frame and a 3-2 frame separated from each other and,
wherein the electrically operated bicycle further comprises a second hinge part between the 3-1 frame and the 3-2 frame and configured to bend the third frame in a direction in which the front wheel and the rear wheel overlap with each other.

14. The electrically operated bicycle of claim 12, wherein the third frame comprises at least one bent portion.

15. The electrically operated bicycle of claim 12, further comprising a fourth frame between the third frame and at least one of the first fixing member and the second fixing member.

16. The electrically operated bicycle of claim 15, wherein the fourth frame is configured to be inserted into the third frame.

17. The electrically operated bicycle of claim 15, further comprising a third hinge part provided between the third frame and the fourth frame in such a way that the fourth frame rotates about the third frame.

18. The electrically operated bicycle of claim 15, wherein the fourth frame comprises a 4-1 frame and a 4-2 frame separated from each other,
wherein the electrically operated bicycle further comprises a fourth hinge part provided between the 4-1 frame and the 4-2 frame in such a way that the 4-1 frame rotates about the 4-2 frame, and
wherein the 4-2 frame is configured to be inserted into the third frame.

19. The electrically operated bicycle of claim 15, wherein the fourth frame comprises a 4-1 frame and a 4-2 frame separated from each other and
wherein the electrically operated bicycle further comprises a fifth hinge part between the 4-1 frame and the 4-2 frame and configured to bend the fourth frame in a direction in which the front wheel and the rear wheel overlap with each other.

20. The electrically operated bicycle of claim 12, further comprising:
a fifth frame fixedly coupled to a frame structure of the electrically operated bicycle; and
a sixth hinge part between the fifth frame and at least one of the first fixing member and the second fixing member and configured to rotate the third frame in a direction in which the front wheel and the rear wheel overlap with each other.
